(19) United States
(12) Patent Application Publication
(10) Pub. No.: US 2022/0305409 A1
(43) Pub. Date: Sep. 29, 2022

(54) Method for Removing Solids Submerged in a Polymer-Based Slurry

(71) Applicant: Clean Slurry Technology, Bakersfield, CA (US)

(72) Inventor: Barry Lynn Sorteberg, Pahrump, NV (US)

(73) Assignee: Clean Slurry Technology, Bakersfield, CA (US)

(21) Appl. No.: 17/702,607

(22) Filed: Mar. 23, 2022

Related U.S. Application Data
(60) Provisional application No. 63/165,617, filed on Mar. 24, 2021.

(51) Int. Cl. B01D 21/26; B01D 21/28; B01D 21/00; B01D 21/02; B01D 21/24; B01D 21/32

(52) U.S. Cl. CPC B01D 21/262; B01D 21/286; B01D 21/0039; B01D 21/0093; B01D 21/02; B01D 21/2477; B01D 21/32

(57) ABSTRACT

A method for removing solids submerged in a polymer-based slurry. The present invention filters used polymer-based slurries, containing solids, to return the slurry to a condition that is favorable to the owner. The method utilizes a first collection tank, an agitator, a shaker with a plurality of screens, a desander, a desilter, a centrifuge that removes solids down to a size range of 5-7 microns, and a second collection tank. Each component can be used in tandem depending on the polymer-based slurry characteristics that are required by the owner. The preferred embodiment includes the following steps: obtaining used polymer-based slurry, pumping the slurry into a first collection tank where the slurry undergoes agitation, pumping the slurry through a plurality of screens, pumping the slurry into a desander and/or a desilter, passing the slurry through a screen, and pumping the slurry in centrifuge that removes solids down to a size range of 5-7 microns. After completion of the method, the owner can decide to repeat the steps to obtain a polymer-based slurry in accordance with their requirements.

### FIELD OF THE INVENTION

The present invention relates generally to a method for removing solids submerged in a polymer-based slurry. More specifically, the present invention is a method for filtering unwanted solids from a polymer-based slurry used in ground excavations and other construction projects in order for the polymer-based slurry to be reused in future excavations and construction projects.

### BACKGROUND OF THE INVENTION

The use of drilling fluid for drilled shaft installation and other ground excavations projects is essential to keeping the borehole from caving in during construction. Drilling fluid accomplishes this by making the borehole stable and providing lubrication to prevent soil resistance. One of the most common and increasingly popular drilling fluids is a polymer-based slurry. While the physical characteristics of the polymer-based slurry allow for an effective drilling fluid, these same characteristics make the polymer-based slurry difficult to recycle and reuse. Polymer slurries consist of long hydrocarbon molecules that form a lattice structure to form a polymetric membrane on the inside of the excavation wall. However, these molecules could have potentially great affects on the environment and are subject to disposal regulations. Additionally, it is costly for the slurry owner to dispose of the slurry after every use. It is currently difficult to process used polymer-based slurries because the used slurries contain unwanted solids from the excavation. A method for removing said solids would allow for the slurries to be used again the future projects, which is beneficial to both the environment and the polymer-slurry owner.

An objective of the present invention is to provide a method for removing solids submerged in a polymer-based slurry. More specifically, the present invention takes the polymer-based slurry, containing solids, from construction sites, processes and removes solids to the liking of the slurry owner and returns the slurry for use in the future excavation and construction projects. The present invention provides several different embodiments that filter solids submerged in a polymer-based slurry effectively and consistently with the ultimate goal being to return the polymer-based slurry to a condition that satisfies its original owner. This is accomplished through passing the polymer-based slurry through the several steps as described in the current invention.

### BRIEF DESCRIPTION OF THE DRAWINGS

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

Furthermore, the drawings may contain text or captions that may explain certain embodiments of the present disclosure. This text is included for illustrative, non-limiting, explanatory purposes of certain embodiments detailed in the present disclosure.

FIG. 1 is a block diagram of alternate embodiment of the present invention.

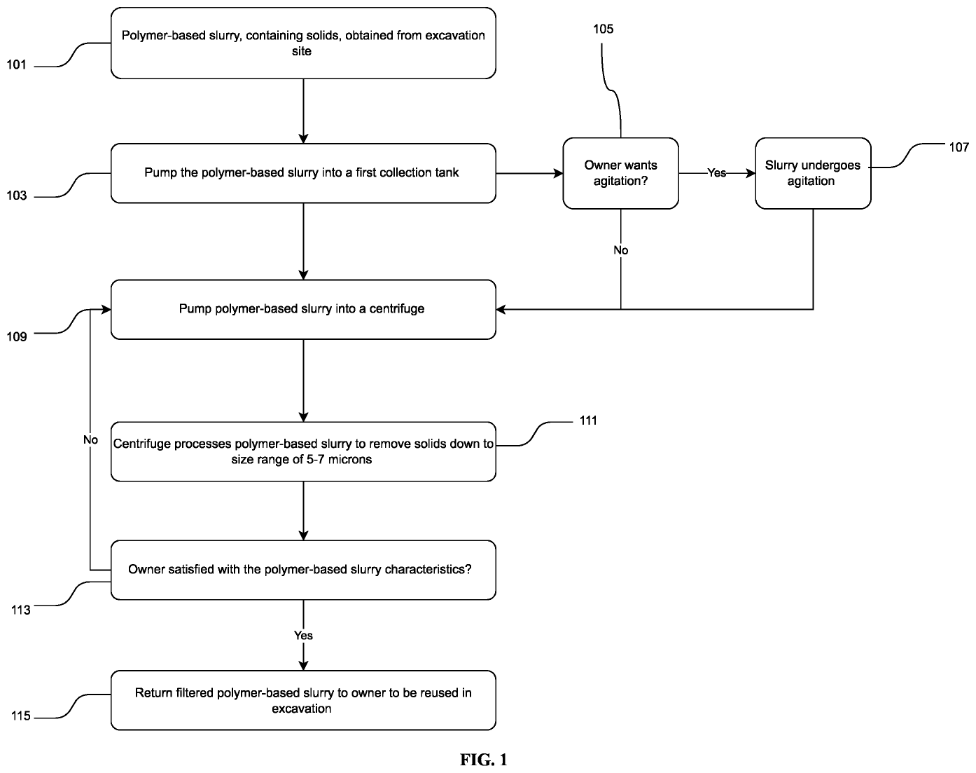

FIG. 2 is a block diagram of an alternate embodiment of the present invention.

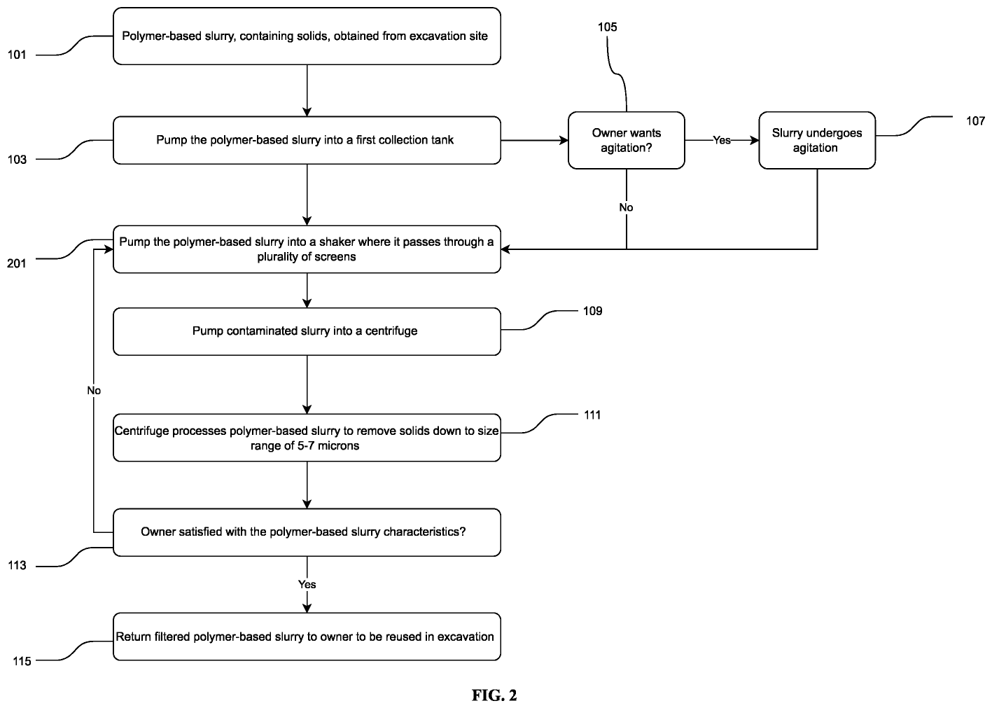

FIG. 3 is a block diagram of a preferred embodiment of the present invention.

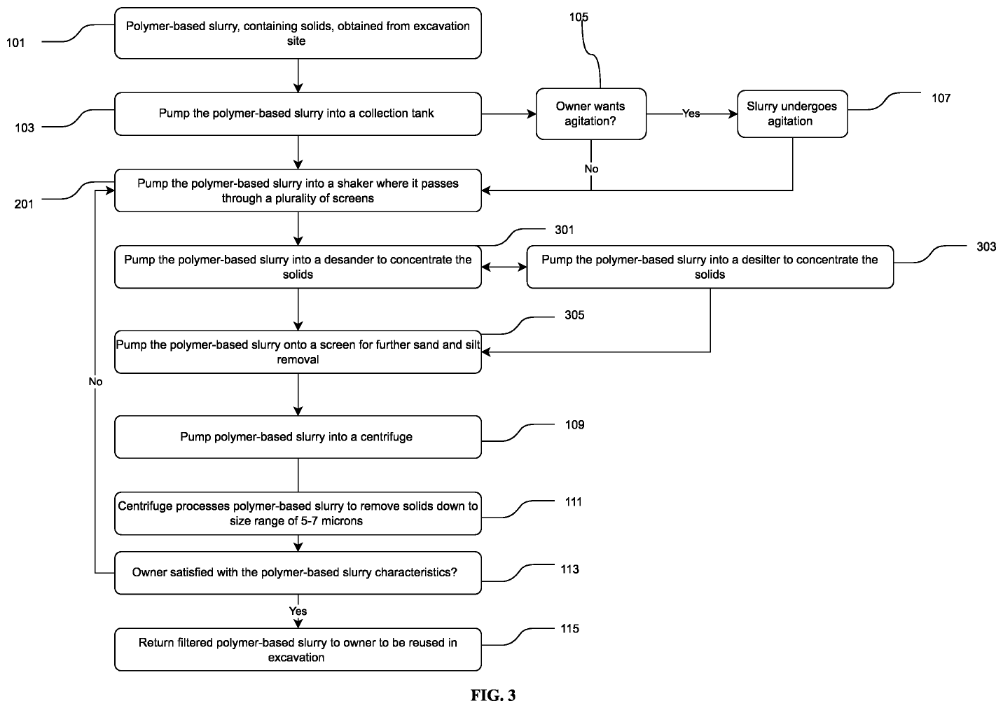

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The present invention relates generally to a method for removing solids submerged in a polymer-based slurry. More specifically, the present invention is a method for filtering unwanted solids from a polymer-based slurry used in ground excavations and other construction projects in order for the polymer-based slurry to be reused in future excavations and construction projects. The method utilizes a pump, a first collection tank, an agitator, a shaker with a plurality of screens, a desander, a desilter, a centrifuge that removes solids down to a size range of 5-7 microns, and second collection tank. Each component can be used in tandem depending on the polymer-based slurry characteristics that are required by the owner. There are three potential embodiments of this method described herein.

One embodiment of present invention is described herein. First, a polymer-based slurry, containing solids, is obtained from an excavation site 101. Solids are considered any foreign object present in the polymer-based slurry, including but not limited to sand, rocks, etc. The polymer-based slurry is then pumped into a first collection tank 103. If the owner would like the polymer-based slurry to undergo agitation by an agitator 105, the polymer-based slurry will then pass through an agitator 107. In the present invention, an agitator is a machine used in a tank to mix components together. The polymer-based slurry will then pass through a centrifuge 109 where the centrifuge processes the slurry to remove solids down to a size range of 5-7 microns 111. In the present invention, a centrifuge is a machine that uses centrifugal force to separate the components of the slurry. If the owner is satisfied with the characteristic of the now filtered polymer-based slurry 113, the slurry will be returned to the owner to be reused in future excavation and construction projects 115. If the owner is not satisfied with the characteristics of the now filtered polymer-based slurry 113, the slurry will return to the centrifuge to begin the method again 109.

Another embodiment of present invention is described herein. First, a polymer-based slurry, containing solids, is obtained from an excavation site 101. Solids are considered any foreign object present in the polymer-based slurry, including but not limited to sand, rocks, etc. The polymer-based slurry is then pumped into a first collection tank 103. If the owner would like the polymer-based slurry to undergo agitation by an agitator 105, the slurry will then pass through an agitator 107. In the present invention, an agitator is a machine used in a tank to mix components together. The polymer-based slurry will be pumped into a shaker where it passes through a plurality of screens 201. The polymer-based slurry will then pass through a centrifuge 109 where the centrifuge processes the slurry to remove solids down to a size range of 5-7 microns 111. In the present invention, a centrifuge is a machine that uses centrifugal force to separate the components of the slurry. If the owner is satisfied with the characteristic of the now filtered polymer-based slurry 113, the slurry will be returned to the owner to be reused in future excavation and construction projects 115. If the owner is not satisfied with the characteristics of the now filtered polymer-based slurry 113, the slurry will return to the centrifuge to begin the method again 109.

Another embodiment of present invention is described herein. First, a polymer-based slurry, containing solids, is obtained from an excavation site 101. Solids are considered any foreign object present in the polymer-based slurry, including but not limited to sand, rocks, etc. The polymer-based slurry is then pumped into a first collection tank 103. If the owner would like the polymer-based slurry to undergo agitation by agitator 105, the slurry will then pass through an agitator 107. In the present invention, an agitator is a machine used in a tank to mix components together. The polymer-based slurry will be pumped into a shaker where it passes through a plurality of screens 201. The polymer-based slurry will then be transported to a desander 301 and/or a desilter 303. Whether the slurry with pass through either the desander, desilter, or both will depend on the needs of the owner. In the present invention, a desander is a machine with a set of hydrocyclones that separates sand from the polymer-based slurry. In the present invention, a desilter is a machine with a set of hydrocyclones that separates silt from the polymer-based slurry. The polymer-based slurry in then passed through a screen for further sand removal 305. The polymer-based slurry will then pass through a centrifuge 109 where the centrifuge processes the slurry to remove solids down to a size range of 5-7 microns 111. In the present invention, a centrifuge is a machine that uses centrifugal force to separate the components of the slurry. If the owner is satisfied with the characteristic of the now filtered polymer-based slurry 113, the slurry will be returned to the owner to be reused in future excavation and construction projects 115. If the owner is not satisfied with the characteristics of the now filtered polymer-based slurry 113, the slurry will return to the centrifuge to begin the method again 109.

It will be apparent to those skilled in the art that various modifications and variations can be made in the practice of the present invention without departing from the scope or spirit of the invention. Other embodiments of the invention will be apparent to those skilled in the art from considering of the specification and practice of the invention. It is intended that the specification and examples be considered as exemplary only, with a true scope and spirit of the invention being indicated by the following claims

Although the invention has been explained in relation to its preferred embodiment, it is to be understood that many other possible modifications and variations can be made without departing from the spirit and scope of the invention.

What is claimed is:

1. A method for removing solids submerged in a polymer-based slurry, the method comprising the steps of:
(1) pumping a polymer-based slurry, containing solids, into a first collection tank;
(2) pumping the polymer-based slurry from the first collection tank into a centrifuge;
(3) separating the solids from the polymer-based slurry using centrifugal force;
(4) collecting the solids from an outlet located at the bottom of the centrifuge; and
(5) pumping the polymer-based slurry from the centrifuge into a second collection tank.

2. The method for removing solids submerged in a polymer-based slurry of claim 1, where pumping a polymer-based slurry, containing solids, into a first collection tank further comprising the steps of:
agitating the polymer-based slurry using an agitator located in the center of the first collection tank; and
discharging the polymer-based slurry into said pump.

3. The method for removing solids submerged in a polymer-based slurry of claim 1, where separating the solids from the polymer-based slurry using centrifugal force further comprising the step of: separating the solids of 5-7 microns from the polymer-based slurry.

4. The method for removing solids submerged in a polymer-based slurry of claim 1, further comprising the steps of: repeating steps (1)-(5) until the polymer-based slurry meets a predefined ratio of solids to polymer-slurry.

5. The method for removing solids submerged in a polymer-based slurry of claim 1, further comprising the step of repeating steps (1)-(5) until the polymer-based slurry is solid-free.

6. A method for removing solids submerged in a polymer-based slurry, the method comprising the steps of:
(1) pumping a polymer-based slurry, containing solids, into a first collection tank;
(2) pumping the polymer-based slurry from the first collection tank onto a shaker;
(3) pumping the polymer-based slurry from the shaker into a centrifuge;
(4) separating the solids from the polymer-based slurry using centrifugal force;
(5) collecting the solids from an outlet located at the bottom of the centrifuge; and
(6) pumping the polymer-based slurry from the centrifuge into a second collection tank.

7. The method for removing solids submerged in a polymer-based slurry of claim 6, where pumping a polymer-based slurry, containing solids, into a first collection tank further comprising the steps of:
agitating the polymer-based slurry using an agitator located in the center of the first collection tank; and
discharging the polymer-based slurry into said pump.

8. The method for removing solids submerged in a polymer-based slurry of claim 6, where pumping the polymer-based slurry from the collection tank onto a shaker further comprises the step of:
filtering the polymer-based slurry through a plurality of screens.

9. The method for removing solids submerged in a polymer-based slurry of claim 6, where separating the solids from the polymer-based slurry using centrifugal force further comprising the step of: separating the solids of 5-7 microns from the polymer-based slurry.

10. The method for removing solids submerged in a polymer-based slurry of claim 6, further comprising the steps of: repeating steps (1)-(6) until the polymer-based slurry meets a predefined ratio of solids to polymer-slurry.

11. The method for removing solids submerged in a polymer-based slurry of claim 6, wherein steps (1)-(6) are repeated until the polymer-based slurry is solid-free.

12. A method for removing solids submerged in a polymer-based slurry, the method comprising the steps of:
(1) pumping a polymer-based slurry, containing solids, into a first collection tank;
(2) pumping the polymer-based slurry from the first collection tank onto a shaker;
(3) pumping the polymer-based slurry from the shaker into a desander;
(4) pumping the polymer-based slurry from the desander into a desilter;
(5) pumping the polymer-based slurry from the shaker into a centrifuge;
(6) separating the solids from the polymer-based slurry using centrifugal force;
(7) collecting the solids from an outlet located at the bottom of the centrifuge; and
(8) pumping the polymer-based slurry from the centrifuge into a second collection tank.

13. The method for removing solids submerged in a polymer-based slurry of claim 12, where pumping a polymer-based slurry, containing solids, into a first collection tank further comprises the steps of:
agitating the polymer-based slurry using an agitator located in the center of the first collection tank; and
discharging the polymer-based slurry into said pump.

14. The method for removing solids submerged in a polymer-based slurry of claim 12, where pumping the polymer-based slurry from the collection tank onto a shaker further comprises the step of:
filtering the polymer-based slurry through a plurality of screens.

15. The method for removing solids submerged in a polymer-based slurry of claim 12, wherein pumping the polymer-based slurry from the shaker into a desander further comprises the step of:
depositing the polymer-based slurry onto a screen for further sand removal.

16. The method for removing solids submerged in a polymer-based slurry of claim 12, wherein pumping the polymer-based slurry from the desander into a desilter; further comprises the step of:
depositing the polymer-based slurry onto a screen for further sand removal.

17. The method for removing solids submerged in a polymer-based slurry of claim 12, where pumping the polymer-based slurry from the shaker into a desander further comprising the step of: separating the solids of 5-7 microns from the polymer-based slurry.

18. The method for removing solids submerged in a polymer-based slurry of claim 12, further comprising the step of: repeating steps (1)-(8) until the polymer-based slurry meets a predefined ratio of solids to polymer-slurry.

19. The method for removing solids submerged in a polymer-based slurry of claim 12, further comprising the step of: repeating steps (1)-(8) until the polymer-based slurry is solid-free.
